(19) United States
(12) Patent Application Publication
(10) Pub. No.: US 2008/0005025 A1
(43) Pub. Date: Jan. 3, 2008

(54) Method and apparatus for renting electronic media content without requiring returns or physical inventory

(76) Inventors: Henry Joseph Legere, Malden, MA (US); Nicholas Aaron Solter, Tustin, CA (US); Yirong Shen, Stanford, CA (US)

Correspondence Address: NICHOLAS SOLTER, 13010 ROCKBRIDGE CIRCLE, COLORADO SPRINGS, CO, 80921, US

(21) Appl. No.: 11/309,066

(22) Filed: Jun. 15, 2006

(51) Int. Cl. H04L 9/00

(52) U.S. Cl. 705/51

(57) ABSTRACT

One embodiment of the present invention provides a system for renting electronic media content, such as movies, without requiring returns or physical inventory. The media content is stored electronically in a database that is accessed by one or more Media Kiosk computer systems, which provide a user interface and multiple input/output devices for interacting with users, and are located in malls or other public places. Customers can select and download media content from the Media Kiosks onto their Media Transport Devices, which are portable non-volatile storage devices. The customers can play, view, or interact with the media content on their Media Players, which are computer systems with multiple input/output devices suitable for allowing users to play, view, or interact with the media.

### FIELD OF THE INVENTION

The present invention relates to a kiosk-based system for delivery of digital media files to recipients, and in particular embodiments, to delivery of movie files to rental customers.

### RELATED ART

The advent of the digital information age has been accompanied by the proliferation of large digital files such as movies, music, games, pictures, electronic books, software, and others. The fast, secure, and convenient delivery of such files to customers is a fundamental problem in many fields.

One existing solution to this problem is by the physical transport of a storage medium (such as DVDs) that contains the desired file. Brick and mortar video rental stores and online video rental sites such as NetFlix are both examples of this approach. The chief limitation of this approach is that delivery using a physical medium requires having a sufficient number of such media in inventory to meet customer demand. But inventory is finite, and hence popular movies often are out of stock at brick and mortar video rental stores and have extremely long waiting times on NetFlix. Furthermore, transportation of the physical medium is a cause of significant inconvenience for the customer. In the case of brick and mortar stores, the customer must travel to the store both to obtain and to return the medium. In the case of NetFlix, DVDs are transported through the postal system, which can take days for both delivery and return.

Another approach to solving this problem is delivering the files by transmission over electronic networks. However, downloading large files such as a high quality movie file can take many hours even with a fast broadband connection and can take days on a slower connection. Moreover, many potential customers may not even have access to a network connection. Such transmission is also expensive in terms of the bandwidth consumed.

Given the limitations of the existing approaches, a need exists for a system that allows the speedy and convenient delivery of large digital files to customers.

### SUMMARY OF THE INVENTION

One embodiment of the present invention provides a system for renting electronic media content, such as movies, without requiring returns or physical inventory. The media content is stored electronically in a database that is accessed by one or more Media Kiosk computer systems, which provide a user interface and multiple input/output devices for interacting with users, and are located in malls or other public places. Customers can select and download media content from the Media Kiosks onto their Media Transport Devices, which are portable non-volatile storage devices. The customers can play, view, or interact with the media content on their Media Players, which are computer systems with multiple input/output devices suitable for allowing users to play, view, or interact with the media.

In a variation on this embodiment, the Media Kiosk contains capabilities for billing the user for the media content rental, either directly via a credit-card reader, cash receiver, or the like; or by allowing the user to create and log-in to an account which is debited.

In a variation on this embodiment, Digital Rights Management is added to the transferred media content for copy protection, unauthorized reply prevention, expiration of media, and the like.

In a variation on this embodiment, the Media Kiosk is connected to the Internet and accesses media content and user accounts over the network.

In a variation on this embodiment, the Media Player is connected to the Internet and synchronizes its clock or downloads decryption keys over the network.

### DESCRIPTION OF DRAWINGS

Exemplary embodiments of the invention will be described with reference to the accompanying drawings. Like items in the drawings are shown with the same reference numbers. Embodiments of the invention are illustrated by way of example, and not by way of limitation, in the figures of the accompanying drawings.

FIG. 1 is a block diagram depicting a media rental system according to an embodiment.

FIG. 2 is a flow diagram depicting a media rental system according to an embodiment.

FIG. 3 is a block diagram depicting a computer system implementing the Media Kiosk according to an embodiment.

FIG. 4 is a flow diagram depicting the customer experience with the Media Kiosk according to an embodiment.

FIG. 5 is a block diagram depicting a computer system implementing the Media Player according to an embodiment.

### DETAILED DESCRIPTION OF THE INVENTION

In the following description, numerous specific details are set forth in order to provide a thorough understanding of the present invention and to enable any person skilled in the art to make and use the invention. In some instances, well-known features have not been described in detail to avoid unnecessarily obscuring the present invention. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Various aspects and features of example embodiments of the invention are described in more detail hereinafter in the following sections: (1) Functional Overview; (2) Media Kiosk and Media Database; (3) Media Selection, Billing, and Accounts; (4) Media Expiration; (5) Media Transport Device; (6) Media Player.

### Functional Overview

One or more embodiments of the invention relate to a method and apparatus for renting electronic media content without requiring returns or physical inventory. As used herein, the term “electronic media content,” hereafter referred to as simply “media,” refers to any type of entertainment or informational content that can be stored on a non-volatile memory such as a tape, other magnetic medium, optical medium, read-only memory, or the like. Examples of such content include movies, music, television shows, electronic games, electronic books, electronic magazines, and electronic newspapers, but the invention is not limited to any particular type of content. As used herein, the term “renting” refers to lending specific media to customers for a limited amount of time, with or without the customer paying a monetary fee for the rental. As used herein, “returns” refers to the customer returning a physical item to the lender, either by personally delivering it, by mailing it, or by some other mechanism; or to the customer being required to perform any action on or before a specific date or time.

One or more embodiments of the invention relate to a media rental system comprised of three components: (1) Media Kiosk; (2) Media Transport Device; (3) Media Player. The Media Kiosk has access to a database of media, a user interface with which to communicate with customers, and an interface by which to transmit content to the Media Transport Device.

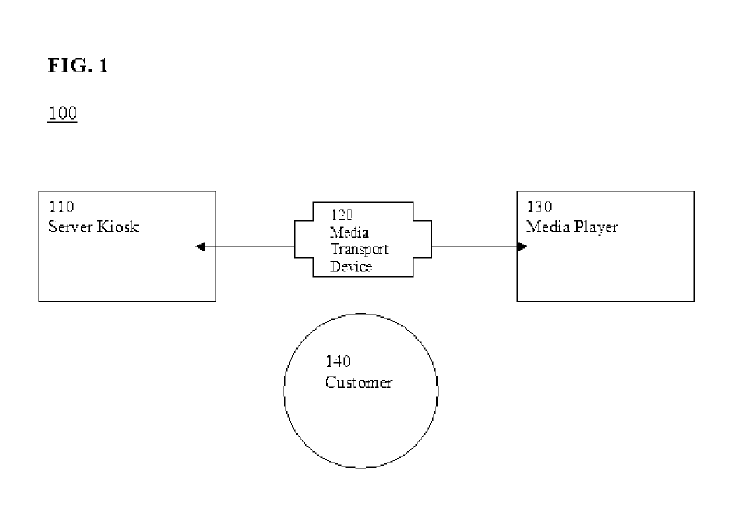

FIG. 1 is a block diagram, 100, of a media rental system in accordance with one or more embodiments of the present invention. A customer, 140, selects desired media content from a Media Kiosk, 110, which is copied to the customer's Media Transport Device, 120. The customer transports the Media Transport Device to his or her Media Player, 130, on which he or she views or plays the media. The customer does not return the media because there is nothing physical to return.

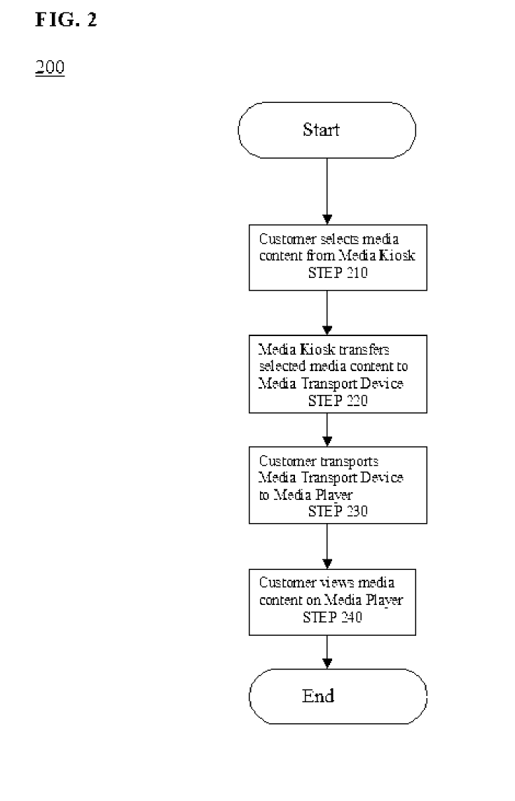

The media rental system just described is now described with reference to a flow diagram 200 of FIG. 2. A customer selects media content from the Media Kiosk in STEP 210. The Media Kiosk transfers the selected media to the customer's Media Transport Device in STEP 220. The customer transports the Media Transport Device to his or her Media Player in STEP 230. The customer views the media on the Media Player in STEP 240.

It will be apparent to one skilled in the art that the Media Transport Device and the Media Player could be one single device. Examples of such devices include a portable music player, a personal digital assistant, or a cell phone, but the invention is not limited to any particular device.

### Media Kiosk and Media Database

In one or more embodiments of the invention, one or more Media Kiosks are located in a location available to customers such as a mall, a retail store, a bank, or a subway station. The invention is not limited to any particular location.

In one or more embodiments of the invention, the Media Kiosk is a computer system that provides access to a database of media. The Media Kiosk allows the customer to select media content from a database of media, and to download the selected media onto the customer's Media Transport Device. More specifically, the Media Kiosk provides an interface for the customer's Media Transport Device by which it can transmit the selected media to the transport device.

In one or more embodiments of the invention, the media database is a relational database. Those skilled in the art will appreciate that this database may take other forms, such as object-oriented or flat-files, and the invention is not limited to any particular type of database.

In one or more embodiments of the invention, the media files are compressed with MPEG compression, mp3 compression, or the like. Those skilled in the art will appreciate that this compression may take other forms, and the invention is not limited to any particular type of compression.

In one or more embodiments of the invention, the Media Kiosk contains capabilities for billing the user for the media rental.

In one or more embodiments of the invention, the Media Kiosk adds Digital Rights Management to the transferred media including an expiration policy for the rented media.

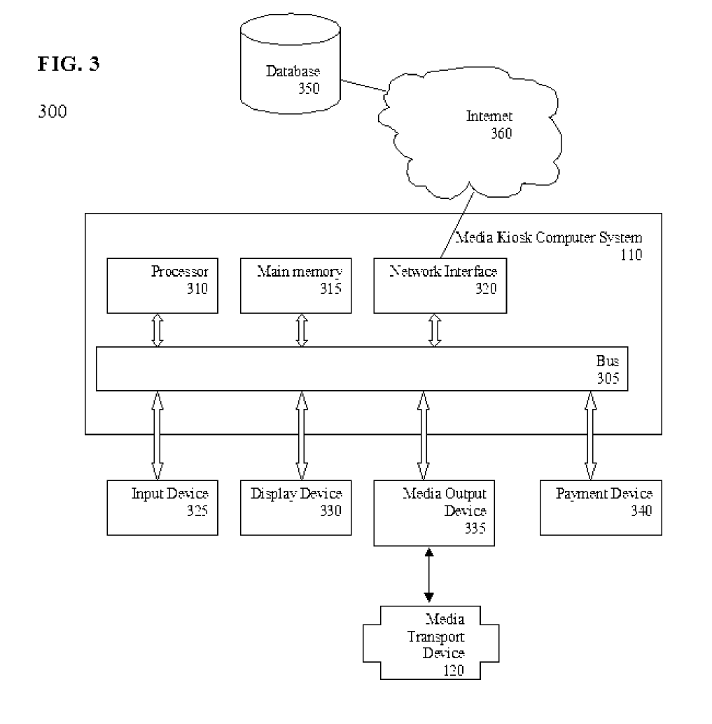

In one or more embodiments, the Media Kiosk may be implemented on virtually any type of computer regardless of the platform being used. FIG. 3 shows a computer system 110 that implements the Media Kiosk in accordance with one or more embodiments of the invention. This computer system includes a processor 310, associated memory 315, a bus or other communication mechanism 305, and numerous other elements and functionalities typical of today's computers (not shown).

The Media Kiosk includes one or more means of input 325, such as a keyboard, mouse, touch-screen monitor, or voice control. Those skilled in the art will appreciate that this input device may take other forms.

The Media Kiosk includes an output means 330 for communicating with the user, such as a display monitor, or voice. Those skilled in the art will appreciate that this output device may take other forms.

The Media Kiosk includes an output means 335 for transferring media to the customer's Media Transport Device, such as a USB port, firewire port, or flash memory disk reader/writer (such as Compact Flash, SD, xD, or Memory Stick). Those skilled in the art will appreciate that this output device may take other forms.

In one or more embodiments of the invention, the Media Kiosk has multiple output means for attaching Media Transport Devices so that more than one user can use the kiosk to transfer media at the same time.

The Media Kiosk includes access to a media database 350 stored on one or more non-volatile storage devices such as tape, other magnetic medium, optical medium, read-only memory or the like. In one embodiment of the invention, this storage is directly attached to the Media Kiosk computer system.

In one or more embodiments of the invention, the Media Kiosk is connected to the Internet 360 through a network interface 320. It could also connect a Local-Area Network, a Wide-Area Network, or a combination of networks.

In one or more embodiments of the invention, the Media Kiosk accesses the media database 350 over its computer network. The media database could be Network Attached Storage, directly-attached storage to a server accessible over the network, or the like. Those skilled in the art will appreciate that the storage device connectivity may take other forms.

### Media Selection, Billing, and Accounts

In one or more embodiments of the invention, the Media Kiosk runs user interface software to interact with the user for the purpose of allowing the user to select media to transfer to the Media Transport Device. This interaction may take the form of a Graphical User Interface, a voice-controlled system, or a command-line interface. Those skilled in the art will appreciate that this user interface may take other forms.

The user interface software provides capabilities for the user to view the available media files, to search for media files based on title, performer, genre, or the like, and to select one or more files for rental.

In one or more embodiments of the invention, the user interface allows more than one user to interact with the Media Kiosk simultaneously.

In one embodiment of the invention, the computer system contains one or more mechanisms (340 in FIG. 3) to obtain direct payment from the user such as a credit-card reader, cash receiver, or the like. Those skilled in the art will appreciate that these payment devices may take other forms.

In one embodiment of the invention, the Media Kiosk can access user account information, which is stored in a database and accessed over the network.

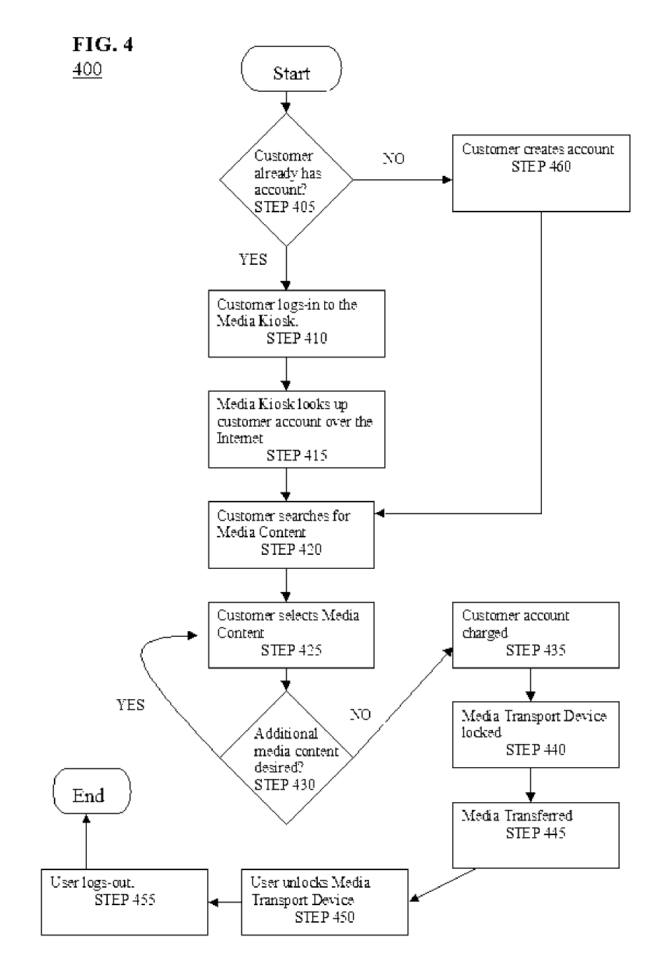

FIG. 4 is a flow chart in accordance with one or more embodiments of the invention, which demonstrates the customer experience with the Media Kiosk. If the user already has an account (STEP 405), she “logs-in” to the Media Kiosk, STEP 410, to access it. The Media Kiosk looks up the account over the network in STEP 415. If the user does not already have an account, she can set one up in STEP 460 with a credit card, Internet payment account, cash, or the like. The user searches for and views available media files in STEP 420. The user selects media to transfer in STEP 425. These steps can be repeated to select multiple media files simultaneously. After the user finishes selecting media, the account is charged in STEP 435. The media is transferred to the user's Media Transport Device in STEP 445. The user logs out of the account in STEP 455.

In one or more embodiments of the invention, the Media Kiosk locks the media transport device in STEP 440 until the user inserts identification, in STEP 450, such as a credit card, so that the user is not required to stay by the Media Kiosk while the media is transferred.

### Media Expiration

In one or more embodiments of the invention, the transferred media includes Digital Rights Management (DRM) to protect the media and cause its expiration. The term “Digital Rights Management,” hereafter referred to as “DRM,” refers to electronic protections on the media for the purpose of copy prevention, unauthorized replay prevention, expiration of media, and the like. The invention is not limited to any particular type of DRM.

In one or more embodiments of the invention, the transferred media is encrypted such that only the Media Player can be used to view the media. This encryption could be shared-key (DES, Blowfish, or another algorithm, either public or proprietary), public-key (RSA, Diffie-Hellman, or another algorithm, either public or proprietary), or the like. The invention is not limited to any particular encryption mechanism or algorithm.

In one or more embodiments of the invention, an expiration policy is embedded in the transferred media. This expiration policy could take the form of an expiration timestamp embedded in the encrypted media file. The media file will only be accessible by the Media Player until that timestamp expires. The expiration policy could also take the form of an embedded tag in the encrypted media file specifying the number of times the media may be viewed.

In one or more embodiments of the invention, copy protection is added to the transferred media. This copy protection could take the form of an embedded disk ID for the customer's Media Player, such that only that player can display the media.

### Media Transport Device

In one or more embodiments of the invention, the Media Transport Device is a portable non-volatile storage device for electronic files. The mechanism of storage could be magnetic, optical, flash-memory, or the like. The invention is not limited by the type of portable storage device.

### Media Player

In one or more embodiments of the invention, the Media Payer is a computer system that allows the user to display, play, view, or interact with media files from the Media Transport Device. The Media Player is typically located in a customer's home, but the invention is not limited to any particular location.

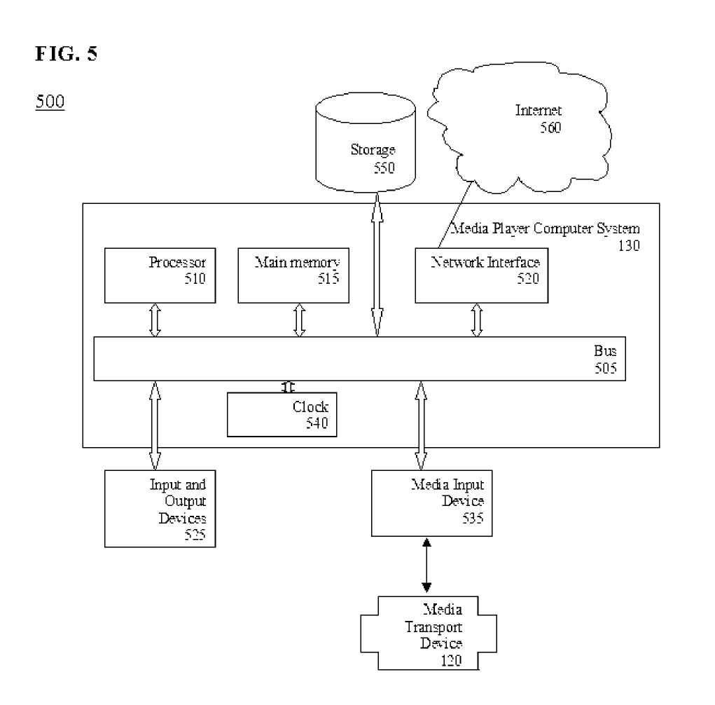

In one or more embodiments, the Media Player may be implemented on virtually any type of computer regardless of the platform being used. FIG. 5 shows a computer system 130 that implements the Media Player in accordance with one or more embodiments of the invention. This computer system includes a processor 510, associated memory 515, a bus or other communication mechanism 505, and numerous other elements and functionalities typical of today's computers (not shown). More specifically, the Media Player could be an embedded system within an electronic appliance. Alternatively, it could be an off-the-shelf personal computer running software to provide the media playing capabilities.

The Media Player includes means of input and output, 525, required for making use of the media files from the Media Transport Device, such as audio speakers, video display, keyboard, mouse, touch-screen monitor, voice control, joystick, and the like. The invention is not limited by the number and types of I/O devices.

In one or more embodiments of the invention, the Media Player includes directly-attached or network-attached non-volatile read/writable storage, 550, such as tape, other magnetic medium, optical medium, or the like, for storing media content.

In one or more embodiments of the invention, the Media Player contains a clock, 540, that can be used for accurate timestamp expiration detection (part of the DRM).

In one or more embodiments of the invention, the Media Player is connected to the Internet, 560, via a network interface, 520. This connection to the Internet allows the Media Player to contain a network-synchronized clock, for use in enforcing the timestamp component of the DRM. The Internet connection could also allow the Media Player to download new decryption keys periodically from a secure network. The Internet connection could also allow the Media Player to inform an accounting server when a media file is viewed or played for billing and accounting purposes.

### Media Playing

The Media Player includes software to interact with the user. The user interface may be a Graphical User Interface, voice controlled interface, or the like. The invention is not limited by the type of interface.

In one or more embodiments of the invention, the Media Player allows the user to display or play media files directly from the Media Transport Device in a random access manner. In one or more embodiments of the invention, the Media Player also allows the user to copy media files to the non-volatile storage attached to the Media Player, from which it allows random access. Additionally, the software contains a search facility to allow users to search for media files based on title, performer, genre, or the like.

This software has the capability to decode the DRM features with which the media is encoded at the download kiosk.

What is claimed is:

1. A method for renting electronic media content to customers without requiring returns or physical inventory, the method comprising:
Allowing a customer to select desired media from a Media Kiosk, which is located in a publicly accessible place and accesses a database of media;
Transferring the selected media to the customer's portable non-volatile storage device called the Media Transport Device;
Allowing the customer to play, view, or interact with the media on his or her Media Transport Device by using his or her personal Media Player.

2. The method of claim 1, wherein the Media Transport Device and the Media Player are one single device.

3. The method of claim 1, further comprising compressing the media stored in the database and on the Media Transport Device with one or more standard or proprietary compression algorithms.

4. The method of claim 1, further comprising allowing the customer to search for desired media content on the Media Kiosk based on title, performer, genre, or the like.

5. The method of claim 1, further comprising accepting payment from the user at the time the media is transferred to the Media Transport Device, via a credit-card reader, cash receiver, or the like.

6. The method of claim 1, further comprising allowing the customers to create accounts on the Media Kiosk system, allowing the Media Kiosks to access this account information over the Internet, allowing the customers to log-in to this account before selecting media to rent, and charging their rentals to this account.

7. The method of claim 1, further comprising the Media Kiosk locking the customer's Media Transport Device until the customer re-identifies him or herself, so that the customer need not wait by the Media Kiosk while the media transfer occurs.

8. The method of claim 1, further comprising the ability of the Media Kiosk to allow more than one customer to access it simultaneously, including simultaneous transferal of selected media to multiple customers' Media Transport Devices.

9. The method of claim 1, further comprising the addition of Digital Rights Management to the transferred media for the purposes of copy prevention, unauthorized replay prevention, media expiration and the like; and wherein the Media Player has the capability to decode the DRM and allow the customer to play, view, or interact with the media content.

10. The method of claim 9, wherein the transferred media is encrypted such that only certain Media Players can be used to play or view the media.

11. The method of claim 10, further comprising including an expiration timestamp in the encrypted media file so that the Media Player will not allow the customer to view or play the media after the media has expired.

12. The method of claim 11, wherein the transferred media includes a tag indicating the number of times the customer is allowed to view or play the media.

13. The method of claim 10, further comprising embedding a disk ID in the transferred media so that only the customer's player can be used to view or play the media.

14. The method of claim 1, further comprising allowing the customer to transfer media content from the Media Transport Device to non-volatile storage directly attached to the Media Player.

15. The method of claim 14, further comprising allowing the customer to search for media files on the Media Player based on title, performer, genre, or the like.

16. The method of claim 14, further comprising allowing the customer random access to the files stored on the Media Player storage.

17. The method of claim 1, further comprising a Media Player that is connected to the Internet.

18. The method of claim 17, further comprising a Media Player that synchronizes its clock over the Internet.

19. The method of claim 17, further comprising a Media Player that downloads decryption keys over the Internet.

20. The method of claim 17, further comprising a Media Player that notifies an account server over the Internet when a customer accesses media content.

21. A computer-implemented apparatus for renting electronic media content to customers without requiring returns or physical inventory, the apparatus comprising:
A computer system called a Media Kiosk that is connected to the Internet and to a database of media content over the Internet, and that includes a user interface by which the user can select desired media content, and input and output devices for communicating with the user to allow the user to select desired media and to transfer that media to a portable non-volatile storage device called a Media Transport Device;
A portable non-volatile storage device called the Media Transport Device;
A computer system called a Media Player that includes a user interface by which the user can play, view, or interact with media from his or her Media Transport Device, and input and output devices for playing, viewing, or interacting with the media.

22. The apparatus of claim 21, wherein the Media Transport Device and the Media Player are one single device.

23. The apparatus of claim 21, wherein the Media Kiosk accesses a database on directly-attached storage.

24. The apparatus of claim 21, wherein the Media Kiosk accesses a database over a Local-Area network.

25. The apparatus of claim 21, further comprising compressing the media stored in the database and on the Media Transport Device with one or more standard or proprietary compression algorithms.

26. The apparatus of claim 21, further comprising a relational database.

27. The apparatus of claim 21, further comprising an object-oriented database.

28. The apparatus of claim 21, further comprising a flat-file database.

29. The apparatus of claim 21, further comprising a user interface that allows the customer to search for desired media content on the Media Kiosk based on title, performer, genre, or the like.

30. The apparatus of claim 21, further comprising input devices that accept payment from the user at the time the media is transferred to the Media Transport Device, via a credit-card reader, cash receiver, or the like.

31. The apparatus of claim 21, further comprising network software that allows the customers to create accounts on the Media Kiosk system, allowing the Media Kiosks to access this account information over the Internet, allowing the customers to log-in to this account before selecting media to rent, and charging their rentals to this account.

32. The apparatus of claim 21, further comprising the Media Kiosk locking the customer's Media Transport Device until the customer re-identifies him or herself, so that the customer need not wait by the Media Kiosk while the media transfer occurs.

33. The apparatus of claim 21, further comprising the Media Kiosk user interface and input/output devices allowing more than one customer to access it simultaneously, including simultaneous transferal of selected media to multiple customers' Media Transport Devices.

34. The apparatus of claim 21, further comprising the addition of Digital Rights Management to the transferred media for the purposes of copy prevention, unauthorized replay prevention, media expiration and the like; and wherein the Media Player has the capability to decode the DRM and allow the customer to play, view, or interact with the media content.

35. The apparatus of claim 34, wherein the transferred media is encrypted such that only certain Media Players can be used to play or view the media.

36. The apparatus of claim 35, further comprising including an expiration timestamp in the encrypted media file so that the Media Player will not allow the customer to view or play the media after the media has expired.

37. The apparatus of claim 36, wherein the transferred media includes a tag indicating the number of times the customer is allowed to view or play the media.

38. The apparatus of claim 35, further comprising embedding a disk ID in the transferred media so that only the customer's Media Player can be used to view or play the media.

39. The apparatus of claim 21, further comprising non-volatile storage directly attached to the Media Player for storing media content from the Media Transport Device.

40. The apparatus of claim 39, further comprising software that allows the customer to search for media files on the Media Player based on title, performer, genre, or the like.

41. The apparatus of claim 39, further comprising software that allows the customer random access to the files stored on the Media Player storage.

42. The apparatus of claim 21, further comprising a Media Player that is connected to the Internet.

43. The apparatus of claim 42, further comprising a Media Player that synchronizes its clock over the Internet.

44. The apparatus of claim 42, further comprising a Media Player that downloads decryption keys over the Internet.

45. The apparatus of claim 42, further comprising a Media Player that notifies an account server over the Internet when a customer accesses media content.
